(19) United States
(12) Patent Application Publication
(10) Pub. No.: US 2021/0207378 A1
(43) Pub. Date: Jul. 8, 2021

(54) SELF-ADHERING CONSTRUCTION PANELS, ASSEMBLIES, AND METHODS

(71) Applicant: GEORGIA-PACIFIC GYPSUM LLC, Atlanta, GA (US)

(72) Inventor: Gunars J. DZENIS, Peachtree City, GA (US)

(21) Appl. No.: 17/059,241

(22) PCT Filed: Apr. 12, 2019
(86) PCT No.: PCT/US2019/027222

§ 371 Date: Nov. 26, 2020

Related U.S. Application Data
(60) Provisional application No. 62/678,368, filed on May 31, 2018.

(51) Int. Cl. E04D 3/04; E04D 3/35; C09J 5/06; E04D 13/16; B32B 7/12; B32B 13/04; B32B 25/16; B32B 17/02

(52) U.S. Cl. CPC E04D 3/04; E04D 3/351; C09J 5/06; E04D 13/1618; B32B 2419/06; B32B 13/042; B32B 25/16; B32B 17/02; B32B 7/12

(57) ABSTRACT

Self-adhering construction panels are methods for their manufacture and installation are provided. A construction panel includes a rigid panel core that includes gypsum or foam, and an adhesive or a precursor of an adhesive disposed on at least a portion of a first surface of the panel in an inactivated or unexposed form, wherein, upon activation or exposure of the adhesive or precursor, the adhesive is configured to secure the panel to a construction assembly.

### CROSS-REFERENCE TO RELATED APPLICATIONS

This is a National Phase Application pursuant to 35 U.S.C. § 371, of International Application No. PCT/US2019/027222, filed on Apr. 12, 2019, which claims priority benefit of U.S. Provisional Patent Application No. 62/678,368, filed May 31, 2018, the disclosures of which are incorporated by reference herein in their entirety.

### BACKGROUND

The present disclosure relates generally to the field of panels and other materials for use in building construction, and more particularly to self-adhering panels and other construction materials, methods of making and installing such panels, and assemblies and systems for their use.

Interior wallboard, exterior building sheathing, flooring, roofing, and other building panels can be exposed to extreme environmental conditions including moisture, wind, and extreme temperatures during and after construction. Additionally, such systems may require labor-intensive precision installation, such that improper installation results in improperly sealed, loose, or otherwise weak or penetrable construction assemblies.

Accordingly, it would be desirable to provide construction panels and other construction materials that provide easy installation and secure construction assemblies.

### SUMMARY

In one aspect, construction panels are provided, including a rigid panel core that comprises gypsum or foam, and an adhesive or a precursor of an adhesive disposed on at least a portion of a first surface of the panel in an inactivated or unexposed form, wherein, upon activation or exposure of the adhesive or precursor, the adhesive is configured to secure the panel to a construction assembly.

In another aspect, roofing panels are provided, including a rigid panel core and an adhesive or a precursor of an adhesive disposed on at least a portion of a first surface of the roofing panel in an inactivated or unexposed form, wherein, upon activation or exposure of the adhesive or precursor, the adhesive is configured to secure the roofing panel to a roof deck assembly.

In yet another aspect, methods of installing such panels are provided, including providing a panel that comprises a rigid panel core and an adhesive or precursor of an adhesive disposed on at least a portion of a first surface of the panel in an inactivated or unexposed form, activating or exposing the adhesive or precursor, and securing the panel to a construction assembly by adhering the adhesive on the first surface of the roofing panel to the construction assembly.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a diagrammatic, fragmentary side elevational view illustrating portions of a manufacturing line for producing gypsum board (generally, boards are also referred to interchangeably as “panels” herein) of a type suitable for use in the manufacture of gypsum panels prepared for use in accordance with the present disclosure;

FIG. 2 is an enlarged fragmentary sectional view, taken as indicated toward the left of FIG. 1, of an underlying fiber glass mat used in the manufacture of the gypsum board;

FIG. 3 is a fragmentary plan view taken as indicated by the line 3-3 on FIG. 2;

FIG. 4 is an enlarged sectional view taken as indicated toward the right on FIG. 1 and illustrating both underlying and overlying fiber glass mats, with intervening gypsum composition, used in the manufacture of the board;

FIG. 5 is a fragmentary plan view taken as indicated by line 5-5 on FIG. 4;

FIG. 6 is a fragmentary bottom view taken as indicated by the line 6-6 on FIG. 4 and illustrating the bottom surface of the underlying mat of the board;

FIG. 7 is a transverse sectional view of an edge portion of the completed board, this view being taken as indicated by the line 7-7 on FIG. 4;

FIG. 8 is a further enlarged fragmentary sectional view taken as indicated toward the top of FIG. 4;

FIG. 9 is a further enlarged fragmentary sectional view taken as indicated toward the bottom of FIG. 4;

FIG. 10 is a perspective view partly broken away and in section of an exemplary prior art roof deck system;

FIG. 11 is an enlarged sectional view taken along line 11-11 of FIG. 10;

FIG. 12 is a greatly enlarged sectional view of the circled area of FIG. 11 showing the penetration of the first asphalt layer into the fibrous upper surface of the panel;

FIG. 13 is a cross-sectional view of a construction panel in accordance with the present disclosure;

FIG. 14 is a cross-sectional view of a construction panel in accordance with the present disclosure;

FIG. 15 is a perspective view of a roof deck assembly in accordance with the present disclosure;

FIG. 16 is a partial perspective view of a roof deck assembly in accordance with the present disclosure;

FIG. 17 is a cross-sectional view of a portion of a prior art roof deck assembly; and

FIG. 18 is a cross-sectional view of a portion of a roof deck assembly in accordance with the present disclosure.

### DETAILED DESCRIPTION

Disclosed herein are building construction panels and materials, as well as methods of making such panels and materials, and systems for their use. Overall, this disclosure is directed to various construction panels and materials for internal and/or external construction applications, for commercial and/or residential applications, in which the construction panels and/or materials are configured for self-adherence to a substrate (e.g., construction assembly, such as a wall or roof deck assembly).

The panels and materials described herein may be panels for internal or external construction applications, such as for wallboard, external sheathing, roof board, and flooring, sound mitigation and rain screen mats, and other construction applications. For example, the panels described herein may be roof panels or other external construction panels, such as those described in U.S. Patent Application Publication No. 2018/0002916, which is incorporated herein by reference in its entirety. For example, the panels described herein may be external gypsum sheathing panels, such as those described in U.S. Patent Application Publications No. 2016/0222646 and 2016/0222656, which are incorporated herein by reference in their entirety. For example, the panels described herein may be fiber-reinforced gypsum panels containing cellulosic fibrous material, such as those described in U.S. Pat. Nos. 6,893,752, 8,070,895, 6,342,284, 6,632,550, 7,244,304, 7,425,236, 7,758,980, 7,964,034, 8,142,914, and 8,500,904, which are incorporated by reference herein in their entirety. For example, the panels described herein may be roof deck panels, such as those described in U.S. Pat. No. 5,319,900, which is incorporated by reference herein in its entirety. For example, the panels described herein may be isocyanurate or similar insulation type panels, such as those described in U.S. Pat. No. 7,612,120, which is incorporated by reference herein in its entirety. For example, the panels described herein may be plywood, oriented strand board (OSB), or other wood-based panels known in the construction industries. For example, the construction materials described herein may be polymeric rain screen or sound mitigation mats, such as those described in U.S. Pat. Nos. 9,157,231 and 7,861,488, which are incorporated by reference herein in their entirety. For example, the panels or construction materials described herein may be gypsum and/or concrete flooring underlayments, such as those described in U.S. Pat. No. 7,651,564, which is incorporated by reference herein in its entirety.

Generally, the disclosure will be described with reference to roof deck panels; however, other construction panels, such as foam, wood, and gypsum panels, including wallboard, insulation, and sheathing panels, are envisioned and intended to fall within the scope of this disclosure. Thus, the disclosure of details relating to the roofing panels should be read as being likewise applicable to other such construction panels. The construction panels and other construction materials described herein may provide easy installation and secure construction assemblies.

### Construction Panels and Materials

Generally, the panels and other construction materials may include any suitable construction or configuration known in the industry. For example, the panels may be panels that contain gypsum as a significant component of the panel core (e.g., in amounts of up to 90 percent, by weight, or more) or may be panels that contain gypsum as a component of the panel core in combination with other components (e.g., in amounts of less than 90 percent). Examples of other components that may be present in the panel core include cellulose or other fibers. Furthermore, while the present disclosure is generally directed to building panels that include a gypsum core or layer, other panels may be suitably substituted for the gypsum panel, such as wood-based, foam-based, and other material-based panels that are suitable for the building construction purposes described herein. That is, while various embodiments of the present disclosure are described or illustrated with reference to a gypsum panel, it should be understood that the gypsum core and other panel features could be replaced with suitable components of these other panel or construction material types. In particular, such panels and other materials are described in the documents incorporated by reference herein. For example, these panels and mats may include any suitable panel core (e.g., one or more layers forming the structural core of the panel) along with any suitable facer material or other external coating material, as will be described herein.

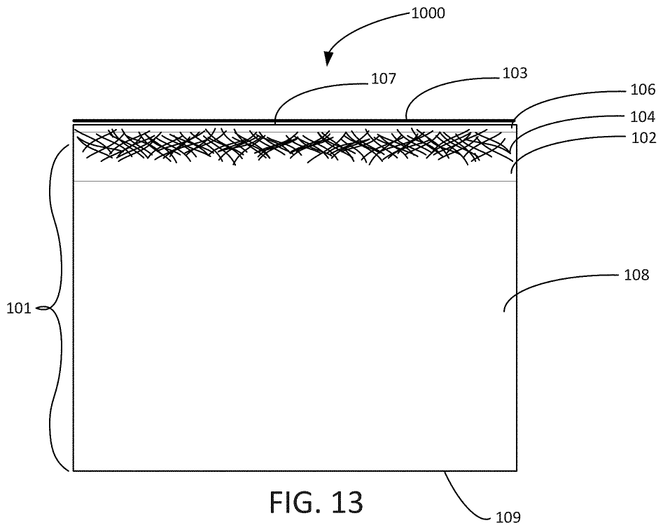

In one aspect, construction panels, such as roofing panels, are provided. As shown in FIG. 13, a panel 1000 includes a rigid panel core 101 having a first surface and a second opposed surface. As used here, the term “rigid panel core” refers to a substantially stiff, inflexible panel suitable for typical use as a construction panel (e.g., roofing panel, sheathing panel, wallboard panel). For example, as discussed above, the panel core may be selected from a gypsum core, a fiber-reinforced gypsum core, an isocyanurate core, a wood-based core, or other known construction panel core materials.

As shown in FIG. 13, the construction panel 1000 has an adhesive or a precursor of an adhesive 103 disposed on at least a portion of a first surface 107 of the panel in an inactivated or unexposed form, such that upon activation or exposure of the adhesive or precursor 103, the adhesive 103 is configured to secure the construction panel 1000 to a substrate. For example, in embodiments in which the construction panel 1000 is a roofing panel, the adhesive 103 may be configured to secure the roofing panel 1000 to a roof deck assembly, as is discussed in greater detail below.

In certain embodiments, as shown in FIG. 13, a panel 1000 includes a gypsum core 101 having a first surface and a second opposed surface, and a first mat facer material 104 associated with the first surface of the gypsum core 101. For example, the facer material may be any suitable facer material known in the art, including paper and fibrous facer materials. In certain embodiments, as shown in FIG. 13, the facer material 104 is a fibrous material, such as fiberglass. Thus, while certain embodiments herein are described with reference to a fiberglass mat, it should be understood that any suitable paper facer or other fibrous mat material may be substituted and fall within the scope of the disclosure.

In certain embodiments, the facer material is a nonwoven fibrous mat formed of fiber material that is capable of forming a strong bond with the material of a building panel core through a mechanical-like interlocking between the interstices of the fibrous mat and portions of the core material. Examples of fiber materials for use in the nonwoven mats include mineral-type materials such as glass fibers, synthetic resin fibers, and mixtures or blends thereof. Both chopped strands and continuous strands may be used.

In certain embodiments, the facer material is a nonwoven fiberglass mat. For example, the glass fibers may have an average diameter of from about 1 to about 17 microns and an average length of from about 1/16 inch to about 1 inch. For example, the glass fibers may have an average diameter of 13 microns (i.e., K fibers) and an average length of ¾ inch. In certain embodiments, the non-woven fiberglass mats have a basis weight of from about 1.5 pounds to about 4.0 pounds per 100 square feet of the mat. The mats may each have a thickness of from about 10 mils to about 50 mils. The fibers may be bonded together to form a unitary mat structure by a suitable adhesive. For example, the adhesive may be a urea-formaldehyde resin adhesive, optionally modified with a thermoplastic extender or cross-linker, such as an acrylic cross-linker, or an acrylate adhesive resin.

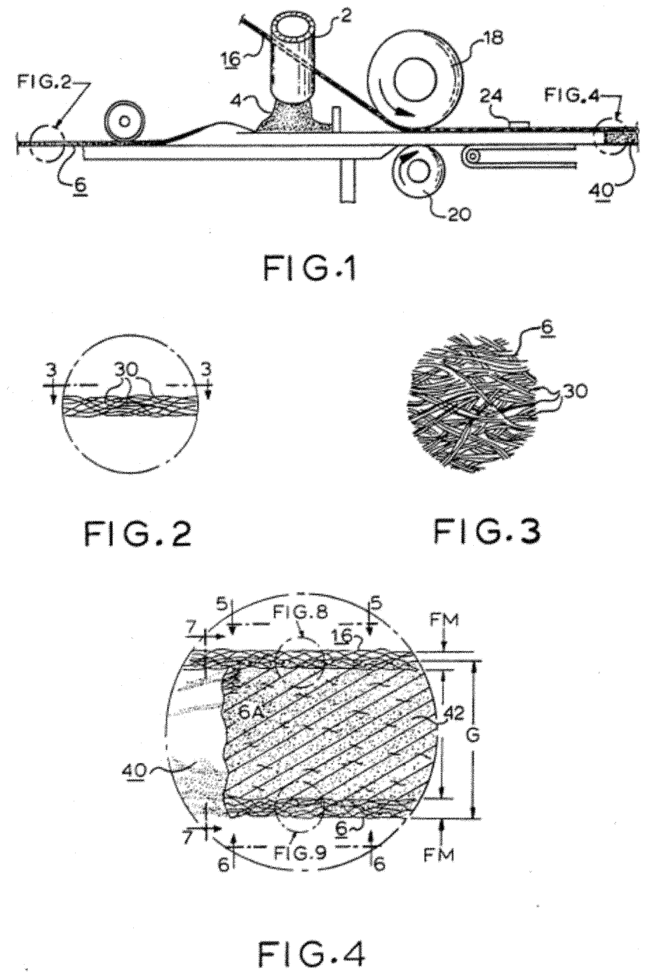

In certain embodiments, as shown in FIGS. 1-4, facer material mats 6 and 16, contain glass fiber filaments 30 oriented in random pattern and bound together with a resin binder (not shown). One embodiment of glass fiber mat-faced gypsum board 40 is shown in FIGS. 4 and 7, in which the set gypsum of the core 42 penetrates substantially through the thickness of the mat 6 over substantial area portions thereof and in which the set gypsum of the core 42 penetrates the mat 16 partially, with the surface being thus substantially free of set gypsum. The gypsum-free surface of mat 16, as seen in FIG. 8, is highly textured, and provides an excellent substrate for adhering thereto an overlying component inasmuch as it contains many interstices into which an adhesive composition can flow and bond.

In certain embodiments, the panels have a thickness from about ¼ inch to about 1 inch. For example, the panels may have a thickness of from about ½ inch to about ⅝ inch.

In some embodiments, as shown in FIG. 13, gypsum crystals of the gypsum core 101 penetrate a remaining portion of the first fiberglass mat 104 such that voids in the first fiberglass mat 104 are substantially eliminated and the water resistance of the panel 1000 is further enhanced. For example, in one embodiment, the first fiberglass mat 104 has a continuous barrier coating 106 on a surface opposite the gypsum core 101, the continuous barrier coating 106 penetrating a portion of the first fiberglass mat 104, to define the remaining portion of the first fiberglass mat 104. That is, gypsum crystals of the gypsum core 101 may penetrate a remaining fibrous portion of the first fiberglass mat 104 such that voids in the first fiberglass mat 104 are substantially eliminated. As used herein the phrase “such that voids in the fiberglass mat are substantially eliminated” and similar phrases refer to the gypsum slurry (e.g., slate coat) filling all or nearly all of the interstitial volume of the fiberglass mat that is not filled by the coating material. As used herein, the term “continuous barrier coating” refers to a coating material that is substantially uninterrupted over the surface of the fibrous mat. The continuous barrier coating on the external surface of the facer may be any suitable coating known in the art. For example, the coating may include a binder material and, optionally, a filler. For example, the coating may include a polymer or resin based binder material along with one or more inorganic fillers.

In other embodiments, no continuous barrier coating is present on the surface of the mat opposite the gypsum core. That is, the adhesive or adhesive precursor 103 may be disposed directly on the mat facer material or on any coating thereon.

In certain embodiments, as shown in FIG. 13, the gypsum core 101 includes two or more gypsum layers 102, 108, while in other embodiments the gypsum core includes a single gypsum layer. For example, the gypsum core may include various gypsum layers having different compositions. In some embodiments, the first gypsum layer 102 that is in contact with the fiberglass mat 104 (i.e., the layer that forms an interface with the coating material and at least partially penetrates the remaining fibrous portion of the first fibrous mat) is a slate coat layer. In some embodiments, the first gypsum layer 102 is present in an amount from about 2 percent to about 20 percent, by weight, of the gypsum core 101. In certain figures, the various gypsum and adhesive layers are shown as separate layers for ease of illustration; however, it should be understood that overlap of these materials may occur at their interfaces.

The layers of the gypsum core may be similar to gypsum cores used in other gypsum products, such as gypsum wallboard, drywall, gypsum board, gypsum lath, and gypsum sheathing. For example, the gypsum core may be formed by mixing water with powdered anhydrous calcium sulfate or calcium sulfate hemihydrate, also known as calcined gypsum, to form an aqueous gypsum slurry, and thereafter allowing the slurry mixture to hydrate or set into calcium sulfate dihydrate, a relatively hard material. In certain embodiments, the gypsum core includes about 80 weight percent or above of set gypsum (i.e., fully hydrated calcium sulfate). For example, the gypsum core may include about 85 weight percent set gypsum. In some embodiments, the gypsum core includes about 95 weight percent set gypsum. The gypsum core may also include a variety of additives, such as accelerators, set retarders, foaming agents, and dispersing agents.

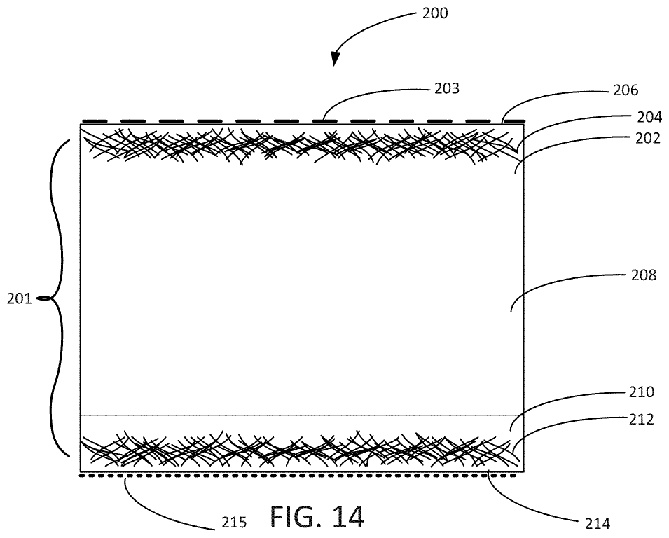

In certain embodiments, as shown in FIG. 14, a gypsum panel 200 includes two facers 204, 212 that are associated with the gypsum core 201. As with the first facer material, the second facer material may be any suitable facer material, such as paper or fibrous materials. In certain embodiments, both facers 204, 212 are fiberglass mats. The second fiberglass mat 212 is present on a face of the gypsum core 201 opposite the first fiberglass mat 204. In some embodiments, only the first fiberglass mat 204 has a continuous barrier coating 206 on a surface thereof. In other embodiments, both fiberglass mats 204, 212 have a coating 206, 214 on a surface thereof opposite the gypsum core 201. In still other embodiments, no continuous barrier coating is present. In some embodiments, the gypsum core 201 includes three gypsum layers 202, 208, 210. One or both of the gypsum layers 202, 210 that are in contact with the fiberglass mats 204, 212 may be a slate coat layer.

As shown in FIG. 13, construction panels 1000 according to the present disclosure may have a first surface 107 of the panel 1000 formed by the first facer material 104, a continuous barrier coating 106 thereon, or another surface-forming material of the panel. The gypsum panel 1000 also has a second surface 109 of the panel opposite the first surface 107. Likewise, as shown in FIG. 14, construction panels 200 according to the present disclosure may have a first surface 206 of the panel 1000 formed by the first facer material 204, or another surface-forming material of the panel. The gypsum panel 200 also has a second surface 214 of the panel opposite the first surface 206.

An adhesive or adhesive precursor may be disposed on at least a portion of the first and/or second surfaces of the panel. As used herein, the term “adhesive” refers to any suitable chemical composition configured to provide the desired adherent force between the panel and a substrate. For example, suitable adhesives may include any adhesives known in the industry, such as solvent-based adhesives, water-based adhesives and low-VOC adhesives. As used herein, the terms “adhesive precursor” and “precursor of an adhesive” (and relevant uses of the term “precursor”) are used to refer to any suitable chemical composition configured to be combined with another suitable chemical composition (including exposure to air) to form an adhesive. For example, suitable adhesive precursors may include any suitable chemical compositions known in the industry.

Suitable adhesives and precursors/activating chemistries may include any of the following: chemical curing adhesives including single component adhesives such as anaerobic, cyanoacrylates, heat cure, moisture cure, radiation cure, and silicones, and two-component adhesives such as epoxies, ethyl methacrylates, silicone adhesives, and urethanes; single component adhesives such as anaerobic, cyanoacrylates, heat cure, moisture cure, radiation cure, and silicones; and two-component adhesives such as epoxies, methyl methacrylates, silicone adhesives, and urethanes.

As shown in FIG. 13, in some embodiments, the adhesive or adhesive precursor 103 is disposed over substantially all of the first surface 107 of the panel 1000. As used herein, the phrase “disposed over substantially all of a surface” refers to the adhesive or precursor covering about 95 percent or more of a surface area of the relevant surface.

As shown in FIG. 14, in some embodiments, the adhesive or adhesive precursor 203 is disposed over only a portion of the surface area of the first surface 206 of the panel 200. For example, the adhesive or the precursor 203 may be disposed on from about 1 to about 100 percent (e.g., 99 or 99.9 percent) of a surface area of the first surface of the roofing panel. For example, the adhesive or the precursor 203 may be disposed on from about 10 to about 100 percent (e.g., 99 or 99.9 percent) of a surface area of the first surface of the roofing panel. For example, the adhesive or the precursor 203 may be disposed on from about 50 to about 100 percent of a surface area of the first surface of the roofing panel. For example, the adhesive or the precursor 203 may be disposed on from about 80 to about 100 percent of a surface area of the first surface of the roofing panel. As used herein, the term “about” is used to refer to plus or minus 2 percent of the relevant numeral that it describes. In some embodiments in which the adhesive or adhesive precursor 203 is disposed over only a portion of the surface area of the first surface 206 of the panel 200, the adhesive or precursor is provided in a patterned format. For example, the adhesive or precursor 203 may be disposed in a pattern of parallel lines, a grid, evenly spaced dots, a serpentine shape, a checkerboard pattern, or any other suitable patterned format.

In certain embodiments, as shown in FIG. 13, an adhesive or precursor 103 is disposed on the first surface 107 of a construction panel 1000. For example, the first surface 107 may be the surface of the panel designed to interface with, and couple to, a substrate of a construction assembly, such as a roof deck assembly. That is, the adhesive 103 (formed from the precursor or provided in the form of the adhesive) is configured to secure the construction panel 1000 to a substrate upon exposing or activating the adhesive/precursor.

In certain embodiments, as shown in FIG. 14, an adhesive or precursor 203 is disposed on the first surface 206 of a construction panel 200, while a second adhesive or precursor 215 (which may be the same or different than that of adhesive or precursor 203) is disposed on the second surface 214 (opposite the first surface) of the construction panel 200. For example, upon activation or exposure of the second adhesive or second precursor, the second adhesive may be configured to secure a membrane, or other suitable film, covering, or material, to the roofing panel. For example, a suitable membrane may be an ethylene propylene diene monomer (EPDM) rubber membrane or another suitable thermoplastic membrane configured to provide the desired water vapor and air barrier properties. Additional examples of suitable membranes or other materials for attachment to the second surface of the panel via adhesive 203 include thermoplastic membranes such as polyvinyl chloride (PVC) and thermoplastic polyolefin (TPO), modified bitumen membranes such as atactic polypropylene (APP), styrene butadiene styrene (SBS) and styrene ethylene/butylene styrene (SEBS). Other membranes suitable membranes include liquid applied, spray foam, metal, and Built Up Roofing (BUR) membranes known in the industry.

The adhesive or adhesive precursor may be disposed on the surface(s) of the panel in an unexposed and/or inactivated form. That is, the adhesive or precursor may be configured such that an activation and/or exposure step is required for the adhesive or precursor to exhibit its adhesive characteristics. For example, prior to activation and/or exposure, the adhesive or precursor (or a covering thereof) may be dry and/or non-adhesive (e.g., non sticky or tacky), such that the panels will not substantially adhere to any substrate prior to activation and/or exposure of the adhesive/precursor. For example, such configuration of the adhesive and/or precursor may beneficially allow for stacked transport of the construction panels having the adhesive and/or precursor applied thereto, without the panels sticking together.

In certain embodiments, the adhesive or precursor is disposed on the surface in an unexposed form that involves the adhesive or precursor being covered by a film covering (not shown). For example, the film covering may be any suitable membrane, paper, film, covering, or other thin skin (terms used interchangeably herein) configured to protect the adhesive or precursor from exposure and that may be easily peeled or otherwise removed from the adhesive or precursor when needed. For example, upon exposure of the adhesive or precursor by removing the film covering, the adhesive may be ready to secure the panel to a substrate. For example, in embodiments in which a precursor is provided with a membrane cover, the precursor may be configured for combination with an activating chemistry to form the adhesive or the precursor may be configured to be activated upon exposure to the air/removal of the membrane cover.

In certain embodiments, the adhesive or precursor is disposed on the surface in an inactivated form that requires some chemical or other manipulation of the adhesive or precursor to achieve the adhesive characteristic of the adhesive. In one embodiment, the precursor is provided in a manner such that application of an activating chemistry thereto is required to form the adhesive. For example, the activating chemistry may be one part of a two-part adhesive chemistry known in the industry. In one embodiments, the adhesive or precursor (used interchangeably in this context) is provided in a manner such that activation of the adhesive characteristics of the material is achieved by application of thermal energy (e.g., heat) thereto. Any suitable mechanism of adhesion may be used to facilitate adhesion between the adhesive and the substrate, including drying, pressure-sensitive adhesion, contact adhesion, heating, and the adhesives may be multi-part, premixed, or one-part adhesives, as described in further detail herein.

In certain embodiments, as shown in FIGS. 10-12 and 15-16, the construction panel having the pre-applied adhesive or precursor may be a roof deck panel. For example, installation of a roof deck system in construction of a building, generally involves constructing a frame for support of the roof of a building; affixing to the frame corrugated sheets to provide a surface for support of the other components of the roof deck system; affixing to the corrugated sheets planar support members; and affixing to the planar support members an exterior finishing material having good weathering properties. Roof deck systems which include panels of insulation sandwiched between the aforementioned corrugated sheets and planar support members are used widely also. Such systems are designed to be insulative in character and weather resistant. Such roof deck systems can be used to advantage to conserve energy used for heating and to conserve energy used for air-conditioning.

More specifically, such roof deck assemblies typically may include corrugated metal sheets which are mechanically affixed, usually by screws or bolts, to appropriate structural members of the building such as steel beams. The corrugated metal sheets support the weight of the components that overlie it, including the insulating material (when used), the planar support members, and the finishing material. Lightweight, low-density insulating panels, such as expanded polystyrene, polyisocyanurate, and the like, are used widely in such systems, especially in colder climates. The planar support members generally include gypsum boards, such as the gypsum construction panels described herein, which are traditionally fastened in place by mechanical fasteners such as screws to the underlying corrugated metal sheet and/or affixed to the insulation or other adjacent structure by a two component low-rise polyurethane foam adhesive. The disadvantages of such traditional methods are discussed below. However, in the present disclosure, the planar support members (i.e., construction panels) are beneficially designed to be adhesively attached to the relevant substrate via a pre-applied (i.e., non-field applied) adhesive or precursor. An exterior finishing material, such as a polymeric or rubber membrane or alternating layers of asphalt and roofing felt, overlies the panels of gypsum board.

A typical roof deck system incorporating the fibrous mat-faced gypsum board as described above is shown in FIGS. 10 to 12. In this construction, spaced parallel trusses 50 extending between building support members (not shown) support a corrugated metal deck 52 that is welded or otherwise fastened to the trusses. Layers 54 and 56 of insulating sheet material, which, for example, may be of polyisocyanurate, are disposed on the corrugated metal deck. In contrast to the panels of the present disclosure, layer 58 of fibrous mat-faced gypsum board panels are secured to the corrugated deck 52 by means of mechanical fasteners 60 passing therethrough and through the underlying insulation layers 54 and 56 into the deck 52. The joints of the panel layer 58 are sealed by application of tape, as shown in FIG. 10 with respect to one of the panel joints. Overlying the gypsum layer 58 is a waterproof roofing membrane including alternate layers of asphalt 64 and roofing felt 66, three layers of each being shown in the present example. A final coating of asphalt 68 is covered with a crushed gravel topping layer 70.

In the enlarged view of FIG. 12, the manner in which the first asphalt layer 64 penetrates into the upwardly facing fibrous mat-face of the gypsum board panel layer 58 is illustrated. This penetration may assure a secure adhesion of the waterproof membrane to the structural layers of the roof system.

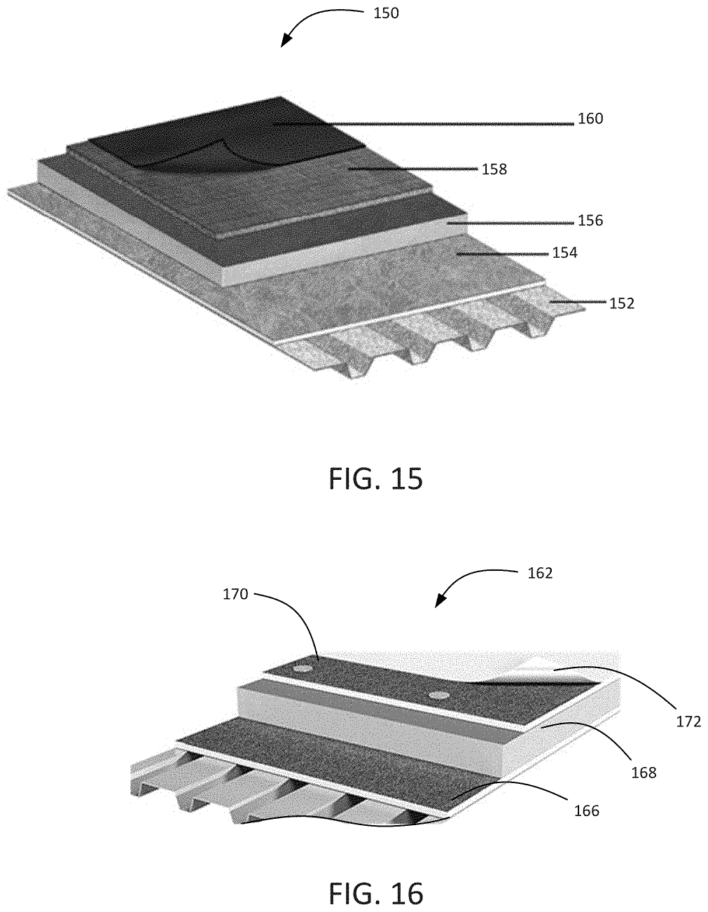

In some embodiments, as shown in FIG. 15, the roof deck system 150 incorporating the construction panels having the pre-applied adhesive or precursor includes a gypsum roof board/panel, as an overlayment 158, underlayment 154, or both, as well as insulation 156 (which could also represent a construction panel having the pre-applied adhesive or precursor), and a roof covering or membrane 160, mounted on a steel, wood, or other roof deck 152 (shown as steel). In some embodiments, as shown in FIG. 16, the roof deck system 162 incorporating the panels having the pre-applied is a single-ply membrane system. For example, the system may include at least one roof panel 166, 170, insulation 168 (which could also represent a construction panel having the pre-applied adhesive or precursor), and a single-ply membrane 172 (e.g., EPDM or thermoplastic membrane), as discussed above. Various embodiments of such roofing systems utilizing gypsum roofing panels are known in the art and the present disclosure is meant to encompass any such suitable system configurations or designs incorporating the panels disclosed herein. For example, the roofing system may incorporate suitable asphalt, EPDM, Turbo Seal, CSPE, Modified Bitumen, PVC, cold liquid membranes, FTPO, TPO, coal-tar pitch built up, or other built up roof constructions, among others.

Thus, the construction panel 1000 may have an adhesive or a precursor of an adhesive 103 disposed on at least a portion of a first surface 107 of the panel in an inactivated or unexposed form, such that upon activation or exposure of the adhesive or precursor 103, the adhesive 103 is configured to secure the construction panel 1000 to a suitable construction substrate. For example, the panel may be configured to be secured to insulation (such as Expanded Polystyrene (EPS), Extruded Polystyrene (XPS), Polyisocyanurate (Polyiso, ISO) or materials such as steel, wood, concrete, gypsum, cementitious wood fiber, composite, or thermoset, as well as other membranes.

As is discussed in greater detail with reference to the methods of installation, the panels and construction materials described herein may reduce the amount of labor required during installation, by eliminating the steps of adhesive application and/or flash time/adhesive setting delay. Further, these panels may provide a more effective, secure, and precise adhering of the panel to the substrate, due to the pre-defined adhesive coverage, which may be tailored for adhesion to a particular substrate material and/or to provide a particular level of adhesion (e.g., to withstand certain wind levels).

### Methods of Manufacture

Methods of manufacturing construction panels and materials described herein are also provided. For example, a gypsum panel, fiber-reinforced gypsum panel, isocyanurate panel, wood-based panel, or other construction material may be manufactured through any suitable means known in these industries.

In certain embodiments of manufacturing a gypsum panel, a gypsum slurry may be deposited on the uncoated surface of the facer material and set to form a gypsum core of the panel. Where the facer material is a fibrous mat, the gypsum slurry may penetrate some remaining fibrous portion of the thickness of the mat (i.e., some portion of the mat that is not already penetrated by the coating) and provide a mechanical bond for the panel. The gypsum slurry may be provided in one or more layers, having the same or different compositions, including one or more slate coat layers. As used herein, the term “slate coat” refers to a gypsum slurry having a higher wet density than the remainder of the gypsum slurry that forms the gypsum core. These methods may be used to produce gypsum panels having any of the features, or combinations of features, described herein. Enhanced penetration of the gypsum into the fibrous mat may be achieved by chemical modification of the gypsum slurry, by application of a penetration-enhancing coating on the surface of the fibrous mat contacted by the gypsum slurry, and/or by mechanical means.

In certain embodiments, the external surface of the fibrous mat is coated with a continuous barrier coating that penetrates a portion of the first fiberglass mat, to define the remaining portion of the first fiberglass mat that gypsum crystals of the gypsum core penetrate, such that voids in the first fiberglass mat are substantially eliminated.

In certain embodiments, the gypsum core includes multiple layers that are sequentially applied to the fiberglass mat, and allowed to set either sequentially or simultaneously. In other embodiments, the gypsum core includes a single layer. In some embodiments, a second fiberglass mat may be deposited onto a surface of the final gypsum slurry layer (or the sole gypsum slurry layer), to form a dual mat-faced gypsum panel. For example, the first and/or second fiberglass mat may include a barrier coating on its surface that penetrates a portion of the mat. The gypsum slurry or multiple layers thereof may be deposited on the fiberglass mat by any suitable means, such as roll coating.

In some embodiments, the gypsum core includes at least three gypsum layers, with the outermost gypsum layers of the gypsum core (i.e., the layers that form an interface with the fiberglass mats). In certain embodiments, both outermost layers are chemically altered for enhanced penetration.

In certain embodiments, the first and/or second fibrous mats are already coated upon contacting the gypsum (or other panel core) slurry. In some embodiments, the methods include applying the continuous coating to the first and/or second fibrous mat, either before or after contacting the mats with the panel core slurry. In certain embodiments, applying the barrier coating includes spray coating, ribbon coating, curtain coating, knife coating, or direct roll coating. In some embodiments, the barrier coating is applied to each of the first and/or second fibrous mats in an amount from about 1 pound to about 9 pounds, per 100 ft². For example, the barrier coating may be applied to the first and/or second fibrous mat in an amount from about 2 pounds to about 8 pounds, per 100 ft². In other embodiments, coated fibrous mats may be obtained in a pre-fabricated form.

In some embodiments, the method also includes mechanically vibrating at least the first fiberglass mat having the first gypsum slurry deposited thereon to effect penetration of the gypsum slurry into the remaining fibrous portion of the first fiberglass mat.

In certain embodiments, the panel core slurry (or layers thereof) may be deposited on the non-coated side of a horizontally oriented moving web of pre-coated fibrous mat. A second coated or uncoated fibrous mat may be deposited onto the surface of the panel core slurry opposite the first coated fibrous mat, e.g., a non-coated surface of the second coated fibrous mat contacts the panel core slurry. In some embodiments, a moving web of a pre-coated or uncoated nonwoven fibrous mat may be placed on the upper free surface of the aqueous panel core slurry. Thus, the panel core material may be sandwiched between two fibrous mats, one or both having a barrier coating. In certain embodiments, allowing the panel core material and/or continuous barrier coating to set includes curing, drying, such as in an oven or by another suitable drying mechanism, or allowing the material(s) to set at room temperature (i.e., to self-harden).

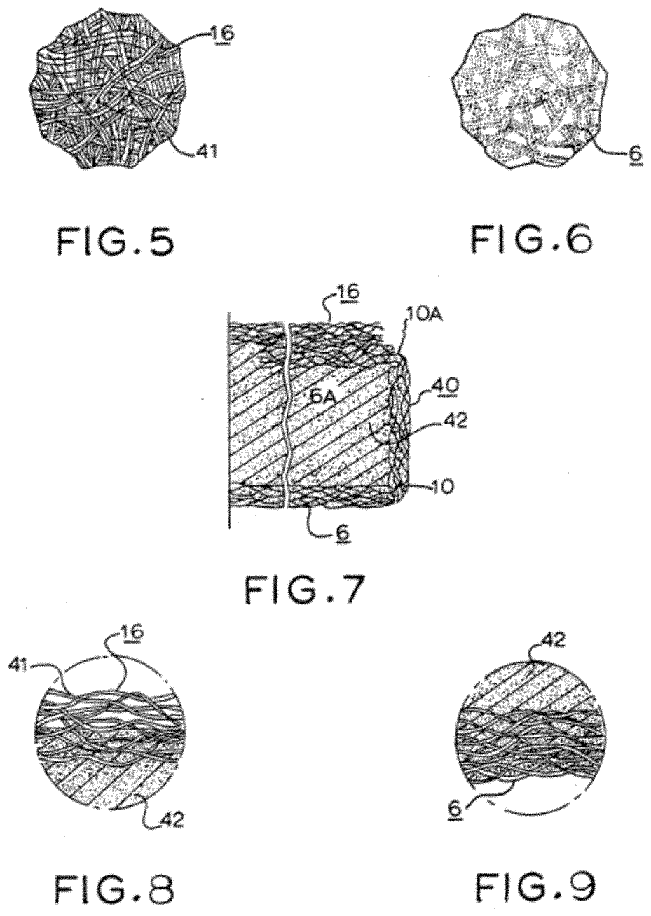

In certain embodiments, as shown in FIGS. 1 to 9, dry ingredients (not shown) from which the gypsum core is formed are pre-mixed and then fed to a mixer of the type commonly referred to as a pin mixer 2. Water and other liquid constituents (not shown) used in making the core are metered into the pin mixer 2 where they are combined with the dry ingredients to form an aqueous gypsum slurry. The slurry 4 is dispersed through one or more outlets at the bottom of the mixer 2 onto a moving sheet of fibrous mat 6. The sheet of fibrous mat 6 is indefinite in length and is fed from a roll (not shown) of the mat. In certain embodiments, the two opposite edge portions of the fibrous mat 6 are progressively flexed upwardly from the mean plane of the mat 6 and then turned inwardly at the margins so as to provide coverings for the edges of the resulting board 40. In FIG. 1, this progressive flexing and shaping of the edges of the mat 6 are shown for only one side edge of the mat and the conventional guiding devices that are ordinarily employed for this purpose are omitted from the figure for the sake of clarity. FIG. 7 shows an edge of the set gypsum core 42 covered by the overlapped edge portion 6A of the mat 6. FIG. 7 shows also score marks 10 and 10A of the mat 6, the score marks permitting the formation of good edges and flat surfaces. The score marks 10 and 10A are made by a conventional scoring wheel 12.

Another sheet of fibrous mat 16 may be fed from a roll (not shown) onto the top of slurry 4, thereby sandwiching the slurry between the two moving fibrous mats that form the slurry. The mats 6 and 16 with the slurry 4 sandwiched therebetween enter the nip between the upper and lower forming or shaping rolls 18 and 20, and are thereafter received on a conveyer belt 22. Conventional edge guiding devices, such as indicated at 24, shape and maintain the edges of the composite until the gypsum has set sufficiently to retain its shape. In due course, sequential lengths of the board are cut and further processed by exposure to heat that accelerates the drying of the board by increasing the rate of evaporation of excess water in the gypsum slurry.

### Applications & Methods of Installation

As discussed above, assemblies of the construction panels described herein, along with methods for their installation are also provided. For example, the assemblies may include any affixing of one or more construction panels having a pre-applied adhesive on a surface thereof to a suitable substrate, via the pre-applied adhesive or an adhesive formed from the precursor. For example, the assembly may be a roofing assembly (i.e., roof deck assembly) as described above.

In certain embodiments, a method of installing a construction panel includes (i) providing a panel that includes a rigid panel core and an adhesive or precursor disposed on at least a portion of the first surface of the roofing panel in an inactivated or unexposed form, (ii) activating or exposing the adhesive or precursor, and (iii) securing the panel to a substrate by adhering the adhesive on the first surface of the panel to the substrate. For example, a method of installing a roofing panel may include securing the roofing panel to a roof deck assembly by adhering the adhesive on the first surface of the roofing panel to the roof deck assembly. Particular roof assemblies and methods of installing roof assemblies are described above. It should be understood that while the panels, assemblies, and methods are described in certain instances herein with reference to a particular set of features, it is envisioned that the various features, details, and designs can be interchanged and substituted to derive various combinations not explicitly recited herein.

In embodiments in which the panel includes a pre-applied unexposed adhesive or precursor utilizing a covering such as a membrane or film, the method of installation includes exposing the adhesive by removing such covering. In embodiments in which the panel includes a pre-applied inactivated precursor, the method of installation may include activating the precursor by exposing the precursor to an activating chemistry (such as air), including applying an activating chemistry to the precursor to form the adhesive. For example, applying the activating chemistry may include spraying or coating the precursor with the activating chemistry. In embodiments in which the panel includes a pre-applied adhesive or precursor, the method of installation may include exposing the adhesive to thermal energy. For example, exposing the adhesive to thermal energy may include heating or melting the adhesive with a torch, a heat gun, or another suitable heat source.

In some embodiments, in which the construction panels include a second surface having a second adhesive or precursor disposed thereon, the method further includes activating or exposing the second adhesive or second precursor and securing a membrane to the panel by adhering the second adhesive on the second surface of the panel to the membrane. For example, the membrane may include any of the suitable membrane or other barrier materials described herein.

In certain embodiments, methods of installation include affixing at least two construction panels to a substrate via the pre-applied adhesive. In some embodiments, the method also includes applying a seaming component at the interface, or joint, between two adjacent panels. In certain embodiments, the seaming component in such systems includes tape or a bonding material. For example, the seaming component may be a tape including solvent acrylic adhesives, a tape having a polyethylene top layer with butyl rubber adhesive, a tape having an aluminum foil top layer with butyl rubber adhesive, a tape having an EPDM top layer with butyl rubber adhesive, a tape having a polyethylene top layer with rubberized asphalt adhesive, or a tape having an aluminum foil top layer with rubberized asphalt adhesive. For example, the seaming component may be a bonding material such as synthetic stucco plasters, cement plasters, synthetic acrylics, sand filled acrylics, solvent based acrylics, solvent based butyls, polysulfides, polyurethanes, silicones, silyl modified polymers, water-based latexes, EVA latexes, or acrylic latexes.

In certain embodiments, the construction panels are roof panels that are designed to be installed in a roof deck assembly, such as the traditional roof deck assemblies described herein and shown in FIGS. 10-12, 15, and 16. For example, the roofing panels having a pre-applied adhesive or precursor may have the adhesive or precursor appropriately activated or exposed such that the adhesive character of the adhesive is achieved. Then the roofing panel may be adhered, via the adhesive, to any suitable substrate of the roof deck assembly, such as an insulation panel or roof deck. Such systems may provide any of various benefits as compared to traditional systems.

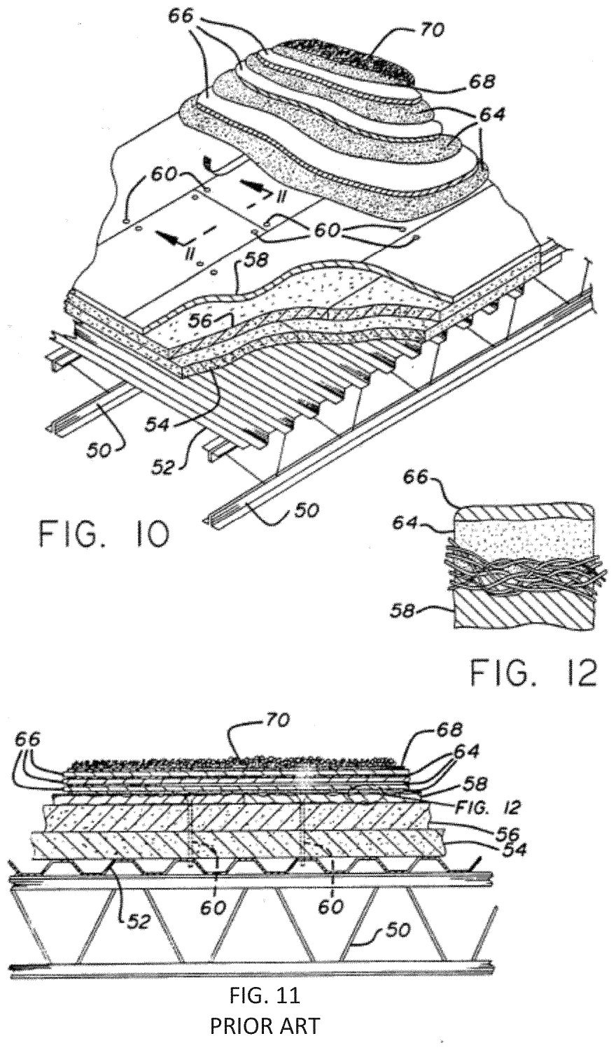

In particular, as discussed above, traditional roofing systems involve one of two types of attachment mechanisms for attaching a gypsum roof panel to the roof deck. First, as illustrated in FIG. 11, a gypsum roof board may be attached to the roof deck via a mechanical faster, such as a screw and plate assembly. Such mechanically fastened assemblies involves significant installation labor, as each panel must be independently fastened into the deck. Additionally, such metal mechanical fasteners have been observed to provide a point for thermal bridging, in which thermal energy (i.e., heat) escapes from the deck through the membrane. Further, it has been observed that the mechanical fastener is typically the weakest spot in a roof assembly, due to the raised plate/screw that results in a raised region that may be susceptible to damage, such as by foot traffic or extreme weather (e.g., hail). Last, the mechanical fasteners create an aesthetically unpleasant surface coverage having plates/raised areas along the roof.

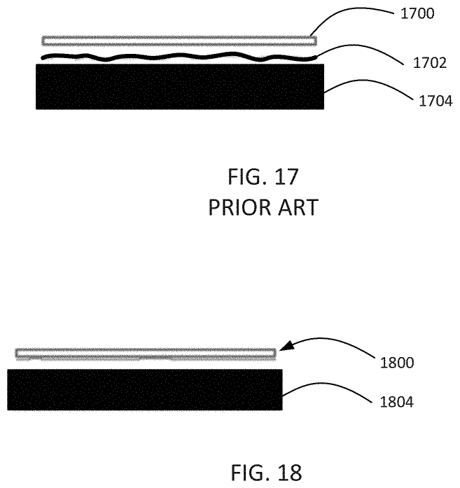

Second, adhesively attached roof panels 1700 are known, which involve in-field preparation and application of a two-component low rise foam adhesive 1702 to the substrate 1704 (e.g., insulation panel), followed by adherence of the roof panel 1700 to the substrate 1704, as illustrated in FIG. 17. The use of such low-rise foam adhesives is a specialized craft that takes years of experience for precise application, and, as such, provides a number of opportunities for error in application. Often, off-ratio issues occur when the two components are not metered/mixed correctly in the field, resulting in ineffective or subpar adhesive quality of the foam. Further, these adhesives suffer from temperature limitations, and typically cannot be applied in winter. Additionally, the person spraying the foam must be careful and even in the spraying, for correct application. There is also a limited amount of time that the panel, with weights, must be laid on top of adhesive for maximum adherence. Depending on temperature and weather conditions, the chemical cure occurs within 4 to 8 minutes and afterwards the adhesive will not adhere properly, creating a possible point for future detachment. It has been discovered that up to ninety percent of such foam-adhered roof errors are either due to improper low-rise foam application or cold welds on the thermoplastic membrane. Moreover, some low rise foams are considered hazardous materials and/or have odors and/or potential hazardous fumes. Last, after the board has been set, the foam adhesive creeps up in-between the boards and the contractor must scrape of the adhesive to maintain a clean flat surface for the membrane.

The presently disclosed construction panels 1800 having a pre-applied adhesive/precursor on their first surface, as shown in FIG. 18, may provide significant advantages as compared to these traditional assemblies. In particular, the pre-applied adhesive panels 1800 reduce the amount of labor required to install the panels on a substrate 1804, because preparation and application of the foam and/or installation of mechanical fasteners, is not required. Even in embodiments requiring application of a chemical activator, film covering removal, or other exposure or activation step, the labor requirements are lower than installation of comparable mechanically fastened or low rise foam systems. Additionally, the risk of application errors is significantly decreased with the presently disclosed panels due to the pre-applied amount and pattern of adhesive being configured to provide suitable strength and coverage to achieve the desired adhesion. Therefore, for the contractor, the benefits are lower installed cost, faster installation and decreased risk of improper installation.

Further, it has been found that certain adhesives can provide higher wind uplift ratings than mechanically attached assemblies. Further, the pre-applied adhesive panels avoid the panel attachment being a weak link within the roof assembly. Thus, these panels may display improved assembly performance as well as increased energy savings.

Also, the presence of potentially hazardous chemicals in the roof assembly can be avoided through the use of the presently described panels, which may container low-VOC and/or water-based adhesives, such that the handling of hazardous chemicals on the roof may be decreased or eliminated.

Last, the pre-applied adhesives and/or precursors may be installed in cold weather, which is currently only an option for mechanical fasteners, allowing for increased installation opportunities.

Accordingly, construction panels and assemblies, and methods for their manufacture and installation have been developed to provide various improvements over currently available systems through the use of a pre-applied adhesive or precursor that allows for efficient and precise installation.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A roofing panel, comprising:
a rigid panel core; and
an adhesive or a precursor of an adhesive disposed on at least a portion of a first surface of the roofing panel in an inactivated or unexposed form,
wherein, upon activation or exposure of the adhesive or precursor, the adhesive is configured to secure the roofing panel to a roof deck assembly.

2. The roofing panel of claim 1, wherein the rigid panel core comprises a gypsum core.

3. The roofing panel of claim 2, wherein the gypsum core is associated with at least one mat facer.

4. The roofing panel of claim 3, wherein the at least one mat facer comprises fiberglass.

5. The roofing panel of claim 1, wherein:
the adhesive is disposed on at least a portion of the first surface of the roofing panel in an unexposed form comprising the adhesive being covered by a film covering, and upon exposure of the adhesive by removing the film covering, the adhesive is configured to secure the roofing panel to a roof deck assembly.

6. The roofing panel of claim 1, wherein:
the precursor is disposed on at least a portion of the first surface of the roofing panel in an inactivated form, and
upon activation of the precursor by application of an activating chemistry thereto to form the adhesive, the adhesive is configured to secure the roofing panel to a roof deck assembly.

7. The roofing panel of claim 1, wherein:
the adhesive is disposed on at least a portion of the first surface of the roofing panel in an inactivated form, and
upon activation of the activation by application of thermal energy thereto, the adhesive is configured to secure the roofing panel to a roof deck assembly.

8. The roofing panel of claim 1, wherein the adhesive or the precursor is disposed across substantially all of the first surface of the roofing panel.

9. The roofing panel of claim 1, wherein the adhesive or the precursor is disposed on from about 1 to about 99.9 percent of a surface area of the first surface of the roofing panel.

10. The roofing panel of claim 1, further comprising a second surface opposing the first surface of the roofing panel, wherein the second surface has a second adhesive or a second precursor of an adhesive disposed thereon, and
wherein, upon activation or exposure of the second adhesive or second precursor, the second adhesive is configured to secure a membrane to the roofing panel.

11. The roofing panel of claim 1, wherein the adhesive comprises a solvent-based adhesive, a water-based adhesive or a low-VOC adhesive.

12. A roofing assembly comprising at least two of the roofing panels of claim 1 secured to an insulation panel of a roof deck assembly.

13. A method of installing a roofing panel, comprising:
providing a roofing panel that comprises a rigid panel core and an adhesive or precursor of an adhesive disposed on at least a portion of a first surface of the roofing panel in an inactivated or unexposed form;
activating or exposing the adhesive or precursor; and
securing the roofing panel to a roof deck assembly by adhering the adhesive on the first surface of the roofing panel to the roof deck assembly.

14. The method of claim 13, wherein the rigid panel core comprises a gypsum core.

15. The method of claim 14, wherein the gypsum core is associated with at least one mat facer.

16. The method of claim 15, wherein the at least one mat facer comprises fiberglass.

17. The method of claim 13, wherein:
the adhesive is disposed on at least a portion of the first surface of the roofing panel in an unexposed form comprising the adhesive being covered by a film covering, and
exposing the adhesive comprises removing the film covering.

18. The method of claim 13, wherein:
the precursor is disposed on at least a portion of the first surface of the roofing panel in an inactivated form, and
activating the precursor comprises applying an activating chemistry to the precursor to form the adhesive.

19. The method of claim 18, wherein applying the activating chemistry comprises spraying or coating the precursor with the activating chemistry.

20. The method of claim 13, wherein:
the adhesive is disposed on at least a portion of the first surface of the roofing panel in an inactivated form, and
activating the adhesive comprises exposing the adhesive to thermal energy.

21. The method of claim 20, wherein exposing the adhesive to thermal energy comprises heating the adhesive with a heat gun or torch.

22. The method of claim 13, wherein:
the roofing panel further comprises a second surface opposing the first surface, wherein the second surface has a second adhesive or a second precursor of an adhesive disposed thereon, and
the method further comprises:
activating or exposing the second adhesive or second precursor; and
securing a membrane to the roofing panel by adhering the second adhesive on the second surface of the roofing panel to the membrane.

23. The method of claim 22, wherein the membrane comprises an ethylene propylene diene monomer rubber membrane.

24. The method of claim 13, wherein the adhesive comprises a solvent-based adhesive, a water-based adhesive or a low-VOC adhesive.

25. The method of claim 13, wherein:
the roof deck assembly comprises an insulation panel, and
securing the roofing panel to the roof deck assembly comprises adhering the adhesive on the first surface of the roofing panel to the insulation panel.

26. A construction panel, comprising:
a rigid panel core that comprises gypsum or foam; and
an adhesive or a precursor of an adhesive disposed on at least a portion of a first surface of the panel in an inactivated or unexposed form,
wherein, upon activation or exposure of the adhesive or precursor, the adhesive is configured to secure the panel to a construction assembly.

27. The panel of claim 25, wherein the rigid panel core comprises a fiber-reinforced gypsum core or an isocyanurate core.

28. The panel of claim 25, wherein the adhesive or the precursor is disposed across substantially all of the first surface of the panel.

29. The panel of claim 25, wherein the adhesive or the precursor is disposed on from about 1 to about 99.9 percent of a surface area of the first surface of the panel.

30. The panel of claim 25, wherein the adhesive or the precursor is disposed on from about 80 to about 99.9 percent of a surface area of the first surface of the panel.
